(19) United States
(12) Patent Application Publication
(10) Pub. No.: US 2018/0146268 A1
(43) Pub. Date: May 24, 2018

(54) Meter Data Request For Metering System

(71) Applicant: HONEYWELL INTERNATIONAL INC, Morris Plains, NJ (US)

(72) Inventors: Sean Scoggins, Rolesville, NC (US); Konstantin Lobastov, Raleigh, NC (US); Peter Richard Rogers, Raleigh, NC (US); Vlad Pambucol, Raleigh, NC (US)

(21) Appl. No.: 15/355,731

(22) Filed: Nov. 18, 2016

(51) Int. Cl. H04Q 9/02; G08C 17/02; G01D 4/00

(52) U.S. Cl. CPC H04Q 9/02; G08C 2200/00; G01D 4/004; G08C 17/02

(57) ABSTRACT

A system and method are provided for storing and transmitting meter data. The system comprises a memory, a processor, and a transceiver. The memory includes a table for storing the meter data. The processor is configured to store a record of meter data for a plurality of time intervals in the table stored in the memory, and further configured to receive a request for the record of meter data at a first time interval of the plurality of time intervals. The transceiver is configured to transmit the record of meter data for the first time interval of the plurality of time intervals.

### BACKGROUND

Metering systems record various types of metering data during metering operations. For example, metering systems may record energy consumption profiling data, energy quantity data, and instrumentation profiling quantity data such as instantaneous and/or average phase voltage, instantaneous and/or average phase current, instantaneous and/or average power factor, or still other meter data. Conventional metering systems are configured to request the metering data from a meter for a particular time interval length, and then only store and report meter data at that time interval length.

The foregoing background discussion is intended solely to aid the reader. It is not intended to limit the innovations described herein. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

Metering data may be recorded in meters at periodic time intervals, which may vary depending on the type of metering data being stored. For example, meters may store instrumentation profiling data at one minute time intervals, which may be maintained in the meter's memory; whereas meters may store energy consumption data at 10 minute intervals. Because energy consumption data can require larger storage capacity than profiling data, the consumption data may be stored for a shorter time period than the profiling data.

The one minute time interval profiling data may allow requests for interval data at any interval length. If a request for profiling data is made for a time interval that is greater than one minute, the stored data may be summed into a longer interval. This approach offers new flexibility, but can complicate the issue of end of interval data snapshots for energy consumption data for validation.

Utilities can use the stored energy consumption data for, for example, billing their customers, which is frequently regulated as to what quality standards the interval data must meet. In conventional metering systems, a meter data management system (MDMS), located at a utility, monitors both data quality (via a “validation” process) and remedies for poor quality data (via an “editing” or “estimation” process).

An almost universal validation process is a “sum check,” which can be required by regulatory bodies. The sum check involves the sum of interval data covering a period of time between two register readings being equal to the difference between the two register values. Implementing this validation process involves meter readings that align with the ends of the period of interest, which may be referred to as bookend register readings. For example, to validate interval data that ends at 01:00, 02:00, 03:00, and 04:00 the system needs register readings at 00:00 and 04:00.

Current systems use different techniques to increase the effectiveness of the validation process. One technique involves reading interval data from a meter that was recorded since the last meter reading, along with the current partial interval data and the current register value. The meter data is validated based on the inclusion of the current partial interval, which includes unfinished data in the validation. The partial interval data can be difficult to reconcile during the validation of the next reading and is also generally not repeatable by systems downstream of the meter reading system.

Another technique used by current systems involves reading interval data along with unaligned register reads, and validating the meter data using a large enough tolerance that a misalignment in time of the interval and register readings does not fail the validation check. However, this approach does not generally produce reliable results.

Another technique involves capturing a snapshot of the meter register value at the end of each time interval, and/or at the end of well-known time intervals such as midnight. The meter reading system reads newly recorded interval data up to the most recently completed interval, and reads the snapshot of the meter register value. The current partial interval data and the current meter register value are not read by the reading system. In this way, the register reading is aligned with the interval data and the metering system only reports completed interval readings.

Disclosed herein is a metering system and method for storing and retrieving metering data that uses a reconfigurable time interval length which improves flexibility, increases reliability of meter interval data, and increases the effectiveness of the validation process.

An aspect of the present disclosure provides a meter for storing one minute energy profile interval data. The meter is configured to allow requests for interval data of any interval length, and further configured to summarize the one minute interval data into longer intervals.

Another aspect of the present disclosure provides a method for storing data in a memory of a metering device. The method comprises: recording, in a table stored in the memory, meter data for each of a plurality of time interval lengths; receiving a request for meter data at a first time interval of the plurality of time interval lengths; and transmitting the meter data for the first time interval of the plurality of time interval lengths.

Another aspect of the present disclosure provides a metering device that includes a memory, a processor, and a transceiver. The memory has a table for storing metering data. The processor is configured to: record meter data for a plurality of time intervals in the table stored in the memory, and receive a request for meter data at a first time interval of the plurality of time intervals. The transceiver is configured to transmit the meter data for the first time interval of the plurality of time intervals.

Another aspect of the present disclosure provides a metering device that includes a memory, a processor, and a transceiver. The memory has a table for storing metering data. The processor is configured to record profiled meter data by a time interval size in the table stored in the memory, and receive a request for the profiled meter data at a first time interval size. The time interval size is reconfigurable. The transceiver configured to transmit the profiled meter data for the first time interval size.

This summary is provided to introduce a selection of concepts in a simplified form that are further described below in the Description of the Invention section. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

A more detailed understanding may be had from the following description, given by way of example in conjunction with the accompanying drawings, wherein:

FIG. 1 illustrates a metering system in which the systems, methods, and apparatus disclosed herein may be embodied.

FIGS. 2A and 2B illustrate schematics of a meter in the metering system of FIG. 1, according to an aspect of the disclosure.

FIG. 3 illustrates a table that includes a plurality of time interval lengths stored in a meter, according to an aspect of the disclosure.

FIG. 4 illustrates another table that includes a plurality of time interval lengths stored in a meter, according to an aspect of the disclosure.

FIG. 5 illustrates a flow diagram for a method of operating a metering system, according to an aspect of this disclosure.

FIG. 6 is a block diagram of an example computing environment that may be used to implement aspects of the metering system illustrated in FIGS. 1 and 2, according to an aspect of this disclosure.

### DESCRIPTION OF THE INVENTION

The disclosure relates generally to metering systems and methods for monitoring consumption of a commodity, such as electricity. It is understood that the systems and methods described herein may be implemented in systems that monitor consumption of other commodities, such as, for example, water or gas. In one embodiment, the metering system includes a plurality of meters communicatively connected to a head-end system. The connection could be a physical connection such as a cable between the meter and the head-end system, a wireless RF connection, or other means.

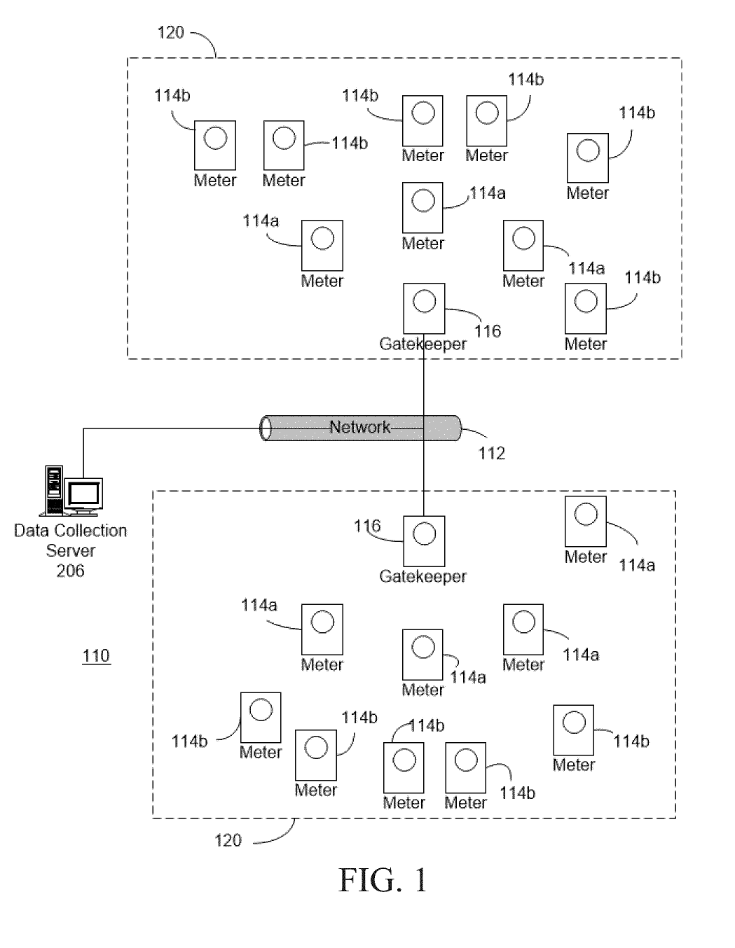

FIG. 1 provides a diagram of one example of a metering system 110 in which the methods, systems, and apparatuses disclosed herein may be employed, it being understood that the methods, systems, and apparatuses disclosed herein are by no means limited to implementation in this example system but rather may be implemented in any system for metering a commodity. The example system 110 comprises a plurality of meters 114, which are operable to sense and record consumption or usage of a service or commodity such as, for example, electricity, water, or gas. Meters 114 may be located at customer premises such as, for example, a home or place of business. Meters 114 comprise circuitry for measuring the consumption of the service or commodity being consumed at their respective locations and for generating data reflecting the consumption, as well as other data related thereto. Meters 114 may also comprise circuitry for wirelessly transmitting data generated by the meter to a remote location. Meters 114 may further comprise circuitry for receiving data, commands or instructions wirelessly as well. Meters that are operable to both receive and transmit data may be referred to as “bi-directional” or “two-way” meters (or nodes), while meters that are only capable of transmitting data may be referred to as “transmit-only” or “one-way” meters. In bi-directional meters, the circuitry for transmitting and receiving may comprise a transceiver.

System 110 further comprises gatekeepers 116. In some embodiments, the gatekeepers 116 may also be referred to as a “collectors” or “routers.” In one embodiment, the gatekeepers 116 are also meters operable to detect and record usage of a service or commodity such as, for example, electricity, water, or gas. In addition, gatekeepers 116 are operable to send data to and receive data from meters 114. Thus, like the meters 114, the gatekeepers 116 may comprise both circuitry for measuring the consumption of a service or commodity and for generating data reflecting the consumption and circuitry for transmitting and receiving data. In one embodiment, gatekeeper 116 and meters 114 communicate with and amongst one another using a frequency hopping communications technique, such as, for example, a frequency hopping spread spectrum (FHSS) technique or direct sequence spread spectrum (DSSS).

In one embodiment, the gatekeepers 116 and the meters 114 with which it communicates define a subnet or local area network (LAN) 120. The LAN 120 may define a controlled, wireless mesh network with the gatekeepers 116 of that LAN effectively controlling the mesh network.

As used herein, the gatekeepers 116 and the meters 114 may be referred to as “nodes” in the subnet/LAN 120. In the subnet/LAN 120, the meters 114 transmit data related to consumption of the commodity being metered at the meter's location. The gatekeepers 116 receive the data transmitted by each meter 114, effectively “collecting” it, and then periodically transmit the data from all of the meters in the subnet/LAN 120 to a data collection server 206 (e.g. utility head-end system). The data collection server 206 stores the data for analysis and preparation of bills, for example. The data collection server 206 may be a specially programmed general purpose computing system and may communicate with gatekeepers 116 via a network 112. The network 112 may comprise any form of network, including a wireless network or a fixed-wire network, such as a local area network (LAN), a wide area network (WAN), the Internet, an intranet, a telephone network, such as the public switched telephone network (PSTN), a Frequency Hopping Spread Spectrum (FHSS) radio network, a mesh network, a Wi-Fi (802.11) network, a Wi-Max (802.16) network, a land line (POTS) network, a TCP/IP network, a W-WAN, a GPRS network, a CDMA network, a Fiber network, or any combination of the above.

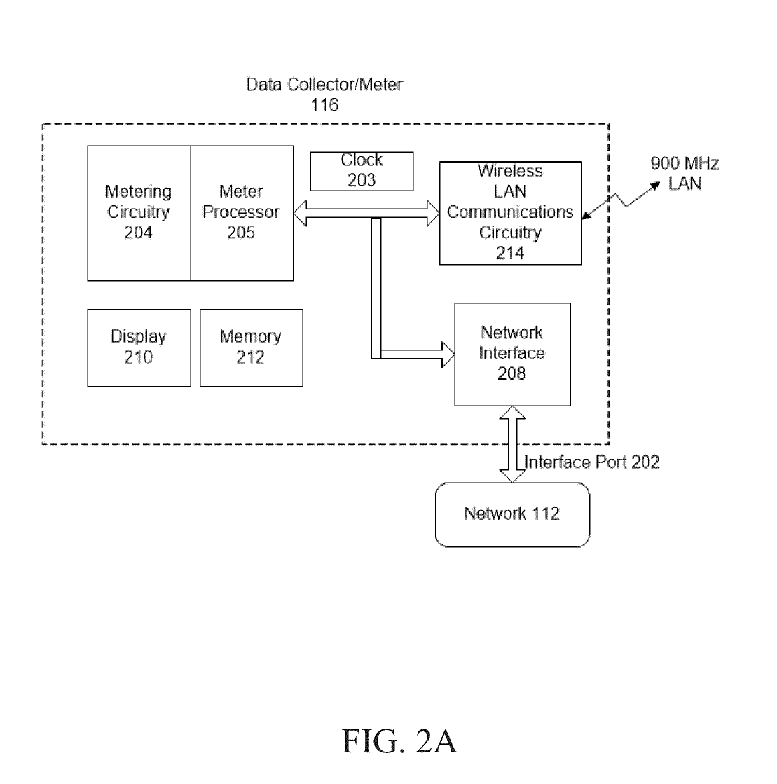

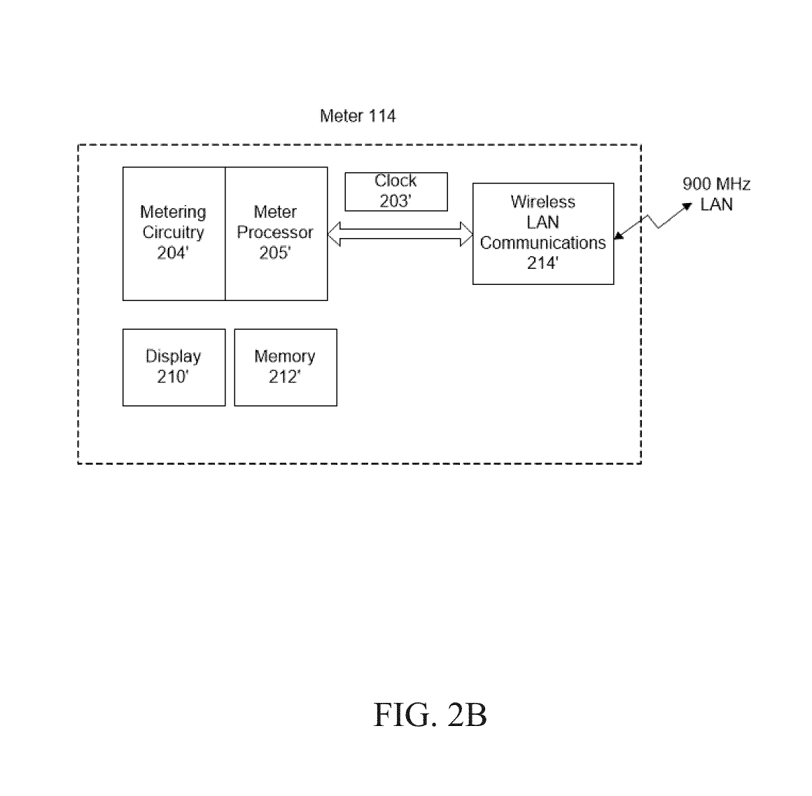

FIG. 2A is a block diagram illustrating further details of one embodiment of a gatekeeper 116. Although certain components are designated and discussed with reference to FIG. 2A, it should be appreciated that the invention is not limited to such components. In fact, various other components typically found in an electronic meter may be a part of gatekeeper 116, but have not been shown in FIG. 2A for the purposes of clarity and brevity. Also, the invention may use other components to accomplish the operation of gatekeeper 116. The components that are shown and the functionality described for gatekeeper 116 are provided as examples, and are not meant to be exclusive of other components or other functionality.

As shown in FIG. 2A, gatekeeper 116 may comprise metering circuitry 204 that performs measurement of consumption of a service or commodity and a processor 205 that controls the overall operation of the metering functions of the gatekeeper 116. The gatekeeper 116 may further comprise a display 210 for displaying information such as measured quantities and meter status and a memory 212 for storing data. The gatekeeper 116 further comprises wireless LAN communications circuitry 214 for communicating wirelessly with the meters 114 in a subnet/LAN and a network interface 208 for communication over the network 112. The communications circuitry 214 may be a two-way communications interface to the data collection server 206 and may comprise any suitable communications interface technology, such as a radio frequency (RF) transceiver, or an interface to the telephone lines or power lines at a utility location, etc. The communications circuitry 214 may communicate with the data collection server 206 over private or public networks.

As further shown, the gatekeeper 116 includes a clock circuit 203. The clock circuit 203 for the gatekeeper 116 may run off an internal 12 MHz crystal and may be adjusted from the central station on a daily basis (or more often). During outages, the clock circuit 203 may keep using a 32 kHz crystal. In an alternative embodiment, the gatekeeper 116 may use a 60 Hz line frequency for additional timing accuracy adjustments.

FIG. 2B is a block diagram of an exemplary embodiment of a meter 114 that may operate in the system 110 of FIG. 1. As shown, the meter 114 comprises metering circuitry 204′ for measuring the amount of a service or commodity that is consumed, a processor 205′ that controls the overall functions of the meter, a display 210′ for displaying meter data and status information, and a memory 212′ for storing data and program instructions. The meter 114 further comprises wireless communications circuitry 214′ for transmitting and receiving data, such as error and warning conditions, to/from other meters 114 or the gatekeeper 116. The wireless communications circuitry 214′ may be similar to or identical to the wireless communication circuitry 214 in the gatekeeper 116 of FIG. 2A. The meter 114 also comprises a clock circuit 203′ like the gatekeeper 116. The clock circuit 203′ may be similar or identical to the clock circuit 203 used in the gatekeeper 116.

The gatekeepers 116 may be responsible for managing, processing and routing data communicated between the gatekeeper 116 and network 112 and between the gatekeeper 116 and meters 114. The gatekeepers 116 may continually or intermittently receive current data from meters 114 and store the data in memory 212 or a database (not shown) in gatekeeper 116. Such current data may include but is not limited to the total kWh usage, the Time-Of-Use (TOU) kWh usage, peak kW demand, other energy consumption measurements, error and warning conditions, or other status information. The gatekeepers 116 also may receive and store previous billing and previous season data from meters 114 and store the data in memory 212 or the database in gatekeeper 116. The database may be implemented as one or more tables of data within the gatekeeper 116.

In an embodiment, the metering system 110 may be an Advanced Metering Infrastructure (AMI) system which uses the ANSI C12.22 protocol for interfacing with the network 112. It should be appreciated that other protocols may be used for the methods and systems for data communications defined herein, for example, ANSI C12.18, and ANSI C12.21. The protocol makes provisions for encrypting data to enable secure communications, including confidentiality and data integrity, for the purpose of interoperability between metering devices and the network.

In an embodiment, the LAN/subnet 120 formed by the gatekeepers 116 and the plurality of meters 114 that communicate with it may operate to form a wireless mesh network that implements FHSS techniques in the 900 MHz ISM band. It should be appreciated that the system and method disclosed herein may comply with Federal Communications Commission (FCC) part 15.247 while providing mechanisms for devices (e.g., meters 114 and gatekeepers 116) to join, register, synchronize, and find neighbors within a LAN/subnet.

The memory 212 may include random access memory (RAM), read-only memory (ROM), non-volatile memory, such as electrically erasable programmable ROM (EEPROM) or flash memory, or combinations thereof. Each meter 114 may maintain in memory 212 different types of time-stamped logs to record various types of event information. The information may include energy profiling data, billing data, instrumentation profiling quantities, such as instantaneous and/or average phase voltage, instantaneous and/or average phase current, instantaneous and/or average power factor, or still other types of meter data.

In a first aspect, the memory 212 may store energy profiling data in a reconfigurable profiling time size interval without reprogramming the meter and without losing any profiling data. In meter 114, the profiling data recorded in memory 212 may be defined by a configuration containing a number of channels to be profiled, a channel data control (e.g. format, algorithm, scale factor), a channel data source, a channel interval length (e.g. in minutes and a factor or multiple of 60). If the metering system 110 uses ANSI C12.19 standard for storing table data, the profiling configuration settings are defined in Decade 6 of the ANSI C12.19 specification. Once the meter's profiling functionality is configured, the meter may start recording profiling data based on the configuration settings.

The meter 114 may store in memory 212 energy profiling data in an internal fixed interval time (e.g. 15 minutes). The profiling data may be dynamically presented in the configured profiling interval length when requested by a user (e.g. utility head-end system). For example, the meter 114 may be configured to record minimum phase voltage and maximum phase voltage channels every fifteen (15) minutes. A 15 minute instrumentation profiling (IP) interval time may be selected by the head-end system to minimize network traffic. However, in the case of a Power Quality Monitoring (PQM) event that triggers a system alarm for low voltage, for example, the head-end system can only look at the minimum and maximum phase voltage profile with a resolution of 15 minutes around the PQM event. This resolution may not be sufficient to analyze the PQM issue. If the head-end system changes the interval time configuration to one minute recording, the IP would typically need to be restarted, and future PQM events could be diagnosed but previously recorded PQM events could not be analyzed using the one minute interval time configuration.

In the first aspect of this disclosure, the meter 114 may be re-configured to record the IP channels with a one minute resolution in memory 212. The recorded data may then be presented to the head-end system based on the system requirements of the head-end system. The system requirements of the head-end system may be changed dynamically. In the example above, if the meter 114 is configured to record with a one minute resolution, the head-end system could request the voltage profile with the one minute resolution around the PQM event. The head-end system could request the voltage profile data from the meter 114 with a one minute resolution, resulting in no profiling reconfiguration or data loss. After assessing the PQM event, if the head-end system returns to requesting data from the meter at a 15 minute time interval, no data will be lost because the meter 114 is configured to record with a one minute resolution.

Multiple head-end systems may retrieve energy profile data from the memory 212 of the meter 114. Each head-end system may need energy profiling data at different interval times. For example, a utility may need energy profiling data in 15 minute intervals, while a regulatory entity may need energy profiling data in 60 minute intervals. Using the first aspect of this disclosure, the energy profiling data is recorded in the meter 114 with a one minute resolution, allowing the data to be supplied to each head-end system at a desired resolution.

In a second aspect of this disclosure, the memory 212 may store data reflecting measured energy consumption in accumulators called registers. The registers, or as referred to in the ANSI C12.19 standard “Table 23 Current Register Data Table” (ST23), comprise a table that stores current billing cycle billing information (energy consumption, demand, and the like). The registers may be read periodically by, for example, head-end systems for the purpose of billing customers or other head-end system needs.

Meter 112 may capture a log of energy consumption data periodically, which is called “interval data” or “load profile data.” An application may include recording the total energy used in a 15 minute period into a register stored in memory 212. The recorded data may be read periodically by a head-end system and used for billing, load research, customer support, or still other processes. Interval data is generally not measured randomly. For example, the 15 minute period in the above example is not arbitrary, but aligned to clock boundaries across the metering network 120. This means that each meter 114 recording energy consumption at 15 minute time intervals records consumption from, for example, 9:00-9:15, then from 9:15-9:30, etc. While register data may be read at any time, new interval data is generally only produced at the end of each time period.

Complications may arise because the end of the time interval length may not be known by the meter 114 in advance of a request for interval data. For example, if the head-end system requests 15 minute data at 2:37, then the latest End of Interval (EOI) data snapshot would have been taken at 2:30. If the same (or another) head-end system requests 5 minute EOI data from the same meter 114 at 2:37, then the latest EOI data snapshot would have been at 2:35. Generally, meters store an EOI data snapshot at the end of each interval they record.

To overcome these issues, the second aspect of this disclosure maintains an EOI data snapshot corresponding to each possible time interval length that the meter 114 can measure. Since time interval lengths may be constrained to align with clock boundaries, the possible time interval lengths may comprise factors of 60 minutes: 1, 2, 3, 4, 5, 6, 10, 12, 15, 20, 30, and 60 minutes, along with multiples of 60 minutes: 120, 180, and 240 minutes. It will be appreciated that fewer or more time interval lengths could be maintained by the meter 114. By maintaining an EOI data snapshot in a register stored in memory 212 for interval data for each time interval length, the meter 114 can make available the most recent EOI data snapshot, regardless of what interval length the head-end system chooses to request. The second aspect is beneficial because it establishes functional parity with typical meters that may only maintain one time interval length and such a meter 114 is easier to integrate with existing head-end systems.

The meter 114 may allocate storage for an EOI data snapshot of a register stored in memory 212 for each configured energy quantity being profiled (i.e. for each interval data channel) and for each time interval length. For example, if the meter 114 is recording two channels of profile data (i.e. kWh-Del and kVARh-Del) and supports multiple time interval lengths (i.e. 1, 2, 3, 4, 5, 6, 10, 12, 15, 20, 30, and 60 minute interval lengths), the meter 114 would need to allocated storage in memory 212 for 24 EOI data snapshots, two channels multiplied by 12 time interval lengths.

The meter 114 may evaluate whether the end of each time interval length corresponds to the end of an available time interval length being stored in memory 212. For example, if the meter 114 is configured to store meter data at a one minute time interval length, then the processor 205 of the meter 114 may determine whether the end of each one minute time period corresponds to the end of an available time interval length. Similarly, if the meter 114 is configured to store meter data at a 15 minute time interval length, then the processor 205 of the meter 114 may determine whether the end of each 15 minute time period corresponds to the end of an available time interval length. If the end of the time period for which the meter 114 is recording corresponds to an available time interval length, the register for that EOI data snapshot stored in memory 212 may be updated with the current interval data (e.g. energy consumption data). The meter 114 may also be configured to store a timestamp of each associated EOI data snapshot. Alternatively, the timestamp of each associated EOI data snapshot may be algorithmically reconstructed.

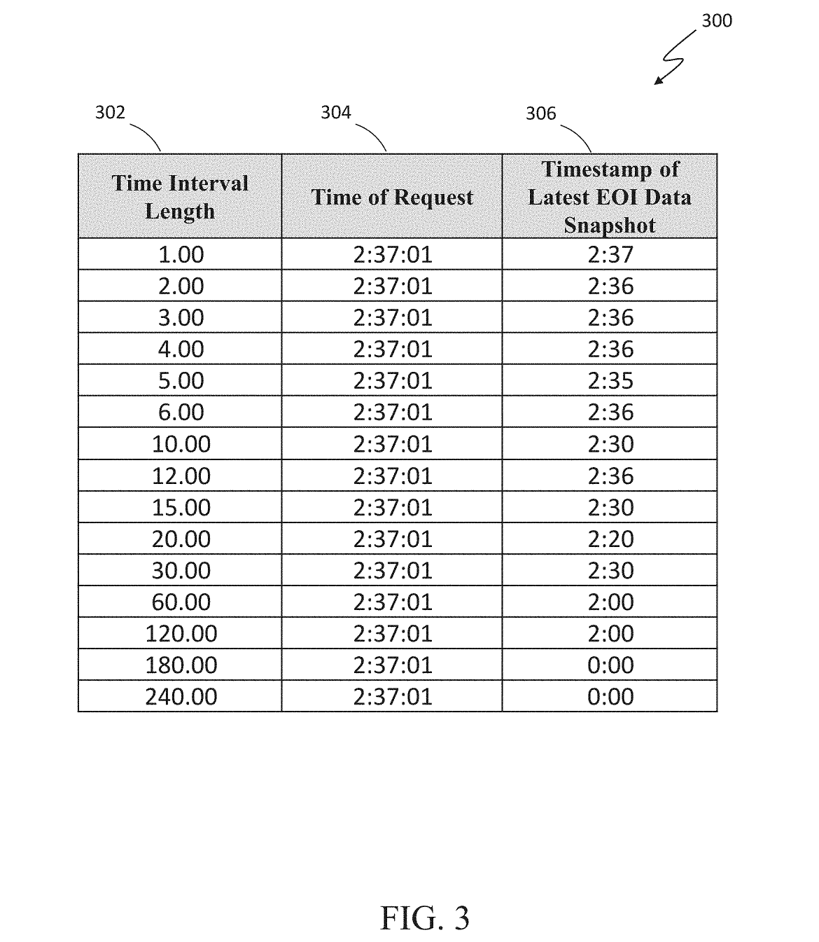

FIG. 3 illustrates a table 300 that represents example records of meter data (e.g. EOI data snapshots) that may be stored in memory 212 of the meter 114, according to the second aspect of this disclosure. The table 300 includes a first column 302 for the time interval length, a second column 304 for a time of request, and a third column 306 for a timestamp of the latest EOI data snapshot. In this example, the meter 114 is configured to store meter data at a one minute time interval length. Meter data has been requested at 2:37:01 by, for example, a head-end system. Table 300 illustrates all of the various EOI data snapshots for each of the time interval lengths listed in the first column 302 (up to 240 minutes) that the meter 114 would have in memory 212 at 2:37:01. If a head-end system requested an EOI data snapshot for a one minute time interval length, the meter 114 would return the meter interval data stored at 2:37. If a head-end system requested an EOI data snapshot for a 15 minute time interval length, the meter 114 would return the meter interval data stored at 2:30. The meter 114 may store a default time interval length in memory 212. Then, if meter interval data is requested without specifying a time interval length, the meter 114 would return the meter interval data stored for the default time interval length. With each data request, the meter 114 may also return the timestamp of the latest EOI data snapshot, which is shown in column 306.

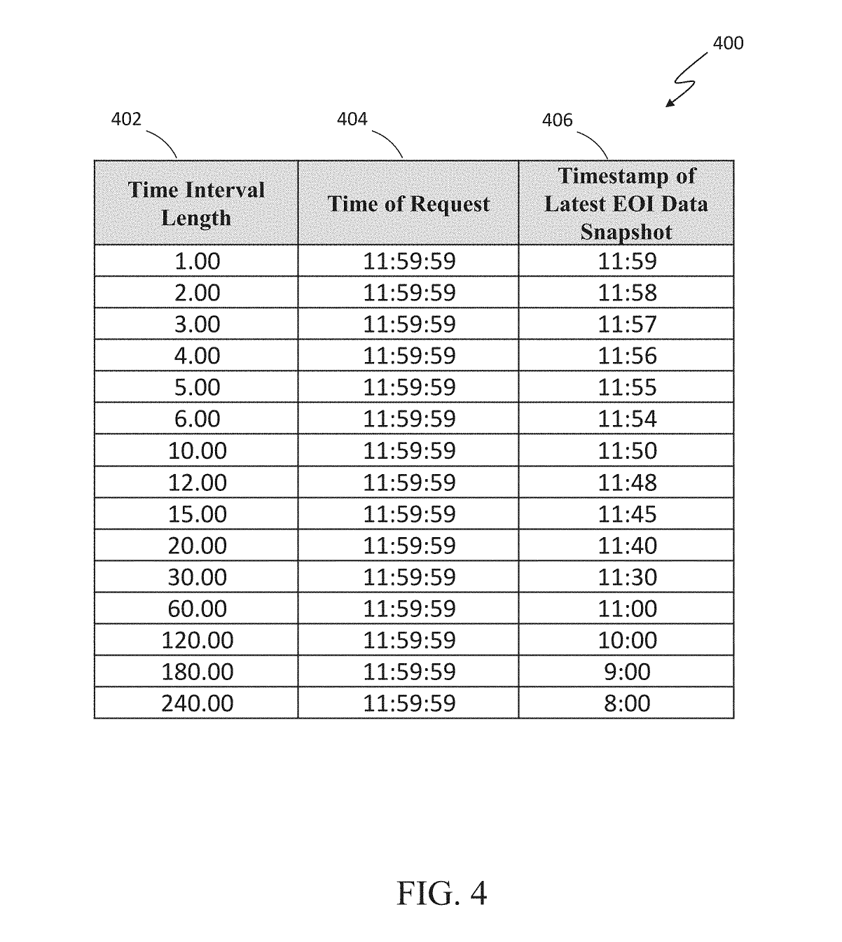

FIG. 4 illustrates a table 400 that represents another example of records of meter data that may be stored in memory 212 of the meter 114, according to the second aspect of this disclosure. Similar to table 300, table 400 includes a first column 402 for the time interval length, a second column 404 for a time of request, and a third column 406 for a timestamp of the latest EOI data snapshot. In this example, the meter 114 is configured to store meter data at a one minute time interval length and meter data has been requested at 11:59:59 by a head-end system. If a head-end system requested an EOI data snapshot for a one minute time interval length, the meter 114 would return the meter interval data stored at 11:59. If a head-end system requested an EOI data snapshot for a 15 minute time interval length, the meter 114 would return the meter interval data stored at 11:45. In another example, if meter interval data had been requested at 12:00:01, each of the EOI data snapshots would return meter data stored at 12:00.

It will be appreciated that table 300 and table 400 are merely demonstrative, and more scenarios or time interval lengths may be contemplated. Further, a single table 300 or 400 may be stored in memory 212, both tables 300 and 400 may be stored in memory 212, or more tables may be stored in memory 212. For example, the number of tables stored in memory 212 may depend upon the number of interval data channels that are being recorded by the meter 114.

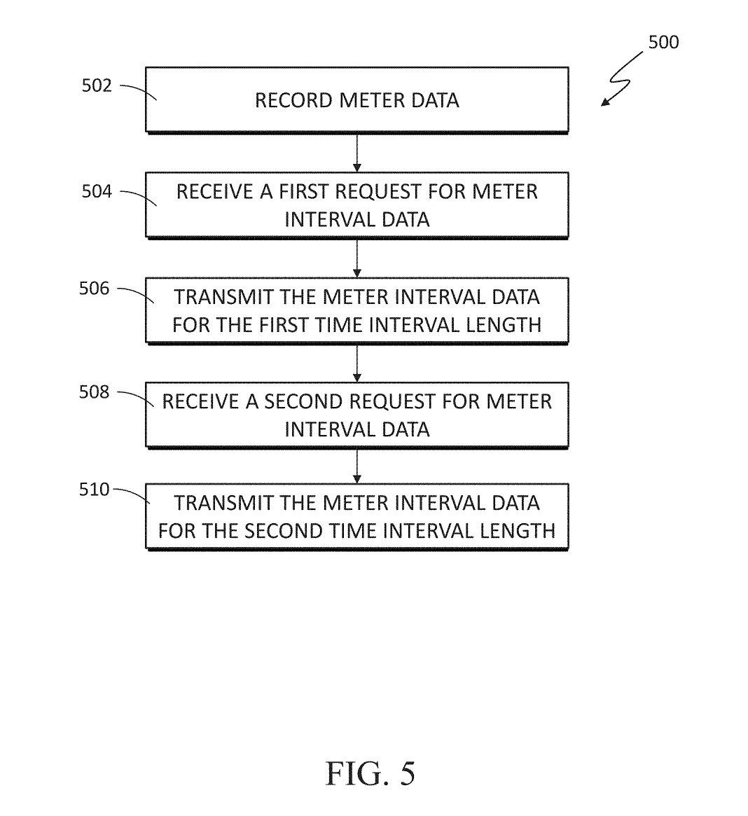

FIG. 5 illustrates a flow diagram 500 for a method of operating the metering system 110 according to the aspects of this disclosure. During operation, the meter 112 may be configured to record meter data (502) for each of a plurality of time interval lengths in a table (or multiple tables) stored in memory 212. The data may be stored at predetermined time interval lengths, default time interval lengths, or requested time interval lengths. As illustrated in tables 300 and 400, the plurality of time interval lengths may include factors and multiples of 60 minutes. The meter 112 may receive a first request for meter interval data (504) at a first time interval length, and transmit the meter interval data for the first time interval length (506). The first request for meter interval data may be performed by a first head-end system, and the transmission of meter interval data may be sent to the first head-end system.

The meter 112 may also receive a second request for meter interval data (508) at a second time interval length, and transmit the meter interval data for the second time interval length (510). The second request for meter interval data may be performed by a second head-end system, and the transmission of meter interval data may be sent to the second head-end system. The first time interval length and the second time interval length may be different.

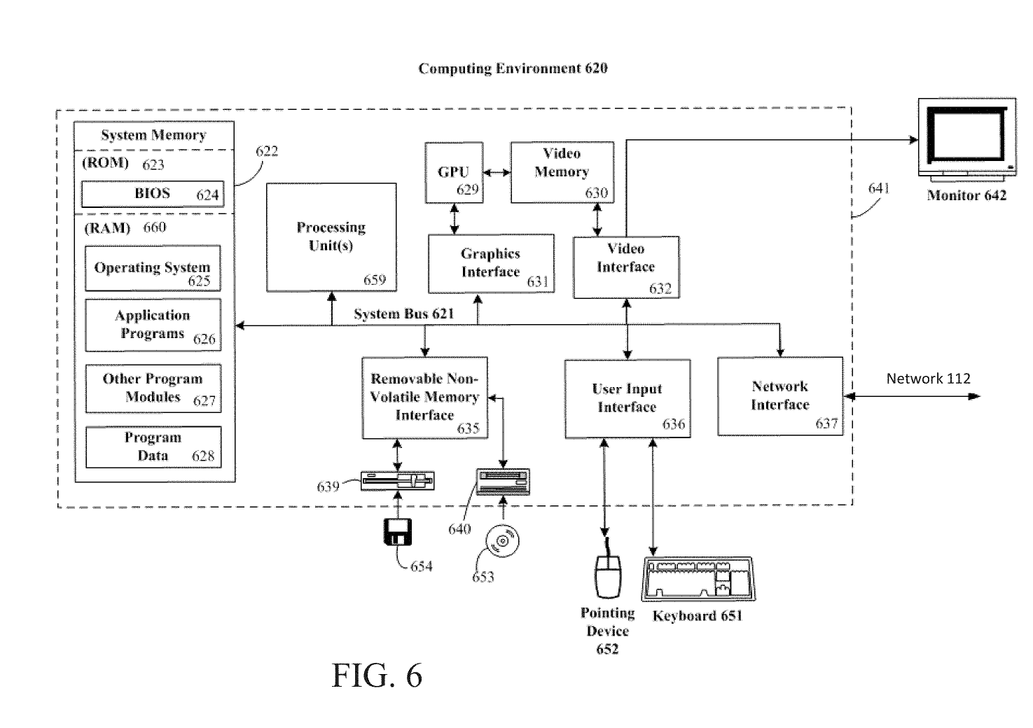

FIG. 6 is an example embodiment of a computing environment 620 of which various aspects of the metering system 110 could be implemented. For example, the computing environment 620 may be used to implement the data collection server 206, or any other aspect of the disclosed system that requires computing. The computing environment 620 is only one example of a suitable computing environment and is not intended to suggest any limitation as to the scope of use or functionality of the presently disclosed subject matter. Neither should the computing environment 620 be interpreted as having any dependency or requirement relating to any one or combination of components illustrated in FIG. 6. In some embodiments, the various depicted computing elements may include circuitry configured to instantiate specific aspects of the present disclosure. For example, the term circuitry used in the disclosure can include specialized hardware components configured to perform function(s) by firmware or switches. In other example embodiments, the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since the state of the art has evolved to a point where there is little difference between hardware, software, or a combination of hardware/software, the selection of hardware versus software to effectuate specific functions is a design choice left to an implementer. More specifically, a software process can be transformed into an equivalent hardware structure, and a hardware structure can itself be transformed into an equivalent software process. Thus, the selection of a hardware implementation versus a software implementation is one of design choice and left to the implementer.

In FIG. 6, the computing environment 620 comprises a computer 641. The computer 641 comprises a processing unit(s) 659, which may comprise a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processing unit(s) 659 may perform signal coding, data processing, power control, input/output processing, and/or any other functionality that enables the computing environment 620 to operate in accordance with its intended functionality. The computer 641 may further comprise a graphics interface, graphics processing unit (GPU), video memory 630, and video interface. These components may cooperate to display graphics and text on a video monitor, such as monitor 642. Processing unit(s) 659 and GPU 629 may receive, generate, and process data related to the methods and apparatuses disclosed herein.

In operation, processing unit(s) 659 fetches, decodes, and executes instructions, and transfers information to and from other resources via the computer's main data-transfer path, system bus 621. Such a system bus connects the components in computer 641 and defines the medium for data exchange. System bus 621 typically includes data lines for sending data, address lines for sending addresses, and control lines for sending interrupts and for operating the system bus. An example of such a system bus 621 is the PCI (Peripheral Component Interconnect) bus. A system memory 622 includes computer storage media in the form of volatile and/or nonvolatile memory such as read only memory (ROM) 623 and RAM 660. A basic input/output system 624 (BIOS), containing the basic routines that help to transfer information between elements within computer 641, such as during start-up, is typically stored in ROM 623. RAM 660 typically contains data, data tables, and/or program modules that are immediately accessible to and/or presently being operated on by processing unit 659. By way of example, and not limitation, FIG. 6 illustrates operating system 625, application programs 626, other program modules 627, and program data 628.

The computer 641 may also include other removable/non-removable, volatile/nonvolatile computer storage media. By way of example only, the computer 641 may include a hard disk drive (not shown) that reads from or writes to non-removable, nonvolatile magnetic media, a magnetic disk drive 639 that reads from or writes to a removable, nonvolatile magnetic disk 654, and an optical disk drive 640 that reads from or writes to a removable, nonvolatile optical disk 653 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Magnetic disk drive 639 and optical disk drive 640 are typically connected to the system bus 621 by a removable memory interface, such as interface 635. The drives and their associated computer storage media discussed above and illustrated in FIG. 6, provide storage of computer readable instructions, data structures, program modules and other data for the computer 641.

A user may enter commands and information into the computer 641 through input devices such as a keyboard 651 and pointing device 652, commonly referred to as a mouse, trackball or touch pad. Other input devices (not shown) may include a microphone, joystick, game pad, satellite dish, scanner, or the like. These and other input devices are often connected to the processing unit 659 through a user input interface 636 that is coupled to the system bus, but may be connected by other interface and bus structures, such as a parallel port, game port or a universal serial bus (USB). The computer may connect to a local area network or wide area network, such as network 112, through a network interface or adapter 637.

Thus, it is understood that any or all of the apparatuses, systems, methods and processes described herein may be embodied in the form of computer executable instructions (i.e., program code) stored on a computer-readable storage medium which instructions, when executed by a processor, such as processing unit(s) 659, cause the processor to perform and/or implement the systems, methods and processes described herein. Specifically, any of the steps, operations or functions described herein may be implemented in the form of such computer executable instructions, executing on the processor of a computing system or other computing apparatus. Computer readable storage media include both volatile and nonvolatile, removable and non-removable media implemented in any non-transitory (i.e., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which can be used to store the desired information and which can be accessed by a computing system.

While the disclosure is described herein using a limited number of embodiments, these specific embodiments are for illustrative purposes and are not intended to limit the scope of the disclosure as otherwise described and claimed herein. Modification and variations from the described embodiments exist. The scope of the invention is defined by the appended claims.

What is claimed is:

1. A method for storing meter data in a memory of a metering device comprising:
recording, in a table stored in the memory, a record of meter data for each of a plurality of time interval lengths;
receiving a request for a record of meter data at a first time interval of the plurality of time interval lengths; and
transmitting, in response to the request, the record of meter data for the first time interval of the plurality of time interval lengths.

2. The method recited in claim 1, wherein the meter data comprises energy consumption.

3. The method recited in claim 1, wherein each of the plurality of time interval lengths comprises a factor of 60 minutes.

4. The method recited in claim 3, wherein the plurality of time interval lengths further comprise 120 minute, 180 minute, and 240 minute time intervals.

5. The method recited in claim 1, wherein the request is a first request, the method further comprising:
receiving a second request for a record of meter data at a second time interval of the plurality of time interval lengths; and
transmitting the record of meter data for the second time interval of the plurality of time interval lengths.

6. The method recited in claim 1, wherein each record of meter data comprises an end of interval memory snapshot.

7. The method recited in claim 1, wherein the table is a first table, and wherein the record of meter data is a first record of meter data, the method further comprising:
recording, in a second table in the memory, a second record of meter data for each of the plurality of time interval lengths, wherein the first record of meter data corresponds to a first channel, and wherein the second record of meter data corresponds to a second channel.

8. The method recited in claim 7, further comprising:
receiving a request for the second record of meter data at a second time interval of the plurality of time interval lengths; and
transmitting the second record of meter data for the second time interval of the plurality of time interval lengths.

9. The method recited in claim 1, further comprising:
recording, in the table stored in the memory, a timestamp for the record of meter data at each of the plurality of time interval lengths.

10. A metering device comprising:
a memory having a table;
a processor configured to:
store a record of meter data for each of a plurality of time intervals in the table stored in the memory, and
receive a request for a first record of meter data at a first time interval of the plurality of time intervals; and
a transceiver configured to:
transmit the first record of meter data for the first time interval of the plurality of time intervals.

11. The metering device recited in claim 10, wherein the request for the first record of meter data is from a utility head-end system, and wherein the first record of meter data is transmitted to the utility head-end system.

12. The metering device recited in claim 10, wherein each of the plurality of time interval lengths comprises a factor of 60 minutes.

13. The metering device recited in claim 12, wherein the plurality of time interval lengths further comprise 120 minute, 180 minute, and 240 minute time intervals.

14. The metering device recited in claim 10, wherein the record of meter data comprises energy consumption.

15. The metering device recited in claim 10, wherein each record of meter data comprises an end of interval memory snapshot.

16. The metering device recited in claim 10, wherein the table is a first table, wherein the processor is further configured to:
record, in a second table stored in the memory, the record of meter data for each of the plurality of time interval lengths, wherein the first table corresponds to a first channel, and wherein the second table corresponds to a second channel.

17. The metering device recited in claim 10, wherein the processor is further configured to:
record, in the table stored in the memory, a timestamp for each record of meter data at each of the plurality of time interval lengths.

18. A metering device comprising:
a memory having a table;
a processor configured to:
store a record of profiled meter data for a time interval size in the table stored in the memory, wherein the time interval size is reconfigurable, and
receive a request for a first record of profiled meter data at a first time interval size; and
a transceiver configured to:
transmit the first record of profiled meter data for the first time interval size.

19. The metering device recited in claim 18, wherein the time interval size comprises one minute.

20. The metering device recited in claim 19, wherein the time interval size is a first time interval size and the request is a first request, and
wherein the processor is further configured to:
receive a second request for a record of energy consumption data at a second time interval size; and
wherein the transceiver is further configured to:
transmit the record of energy consumption data for the second time interval size.
